(19) United States
(12) Patent Application Publication
(10) Pub. No.: US 2022/0286395 A1
(43) Pub. Date: Sep. 8, 2022

(54) SRv6 Segment Identifiers and Micro Segments Invoking Network Behavior including Realization of Network Slices

(71) Applicant: Cisco Technology, Inc., San Jose, CA (US)

(72) Inventors: Rakesh GANDHI, Stittsville (CA); Clarence FILSFILS, Brussels (BE); Zafar ALI, Hicksville, NY (US); Patrice BRISSETTE, Gatineau (CA)

(73) Assignee: Cisco Technology, Inc., a California corporation, San Jose, CA (US)

(21) Appl. No.: 17/453,353

(22) Filed: Nov. 3, 2021

Related U.S. Application Data
(60) Provisional application No. 63/157,810, filed on Mar. 7, 2021.

(51) Int. Cl. H04L 12/741; H04L 12/733

(52) U.S. Cl. CPC H04L 45/745; H04L 45/20

(57) ABSTRACT

In one embodiment, Segment Routing Internet Protocol Version 6 (SRv6) micro segments (“uSIDs”) are included in destination addresses, and possibly in other Segment Identifiers (“SIDs”), of packets transported through a network, and invoking corresponding network behavior, including, but not limited to, realization of corresponding network slices. In one embodiment, network nodes are configured to perform differential network slice realization functionality based on values slice-representative value(s) provided by global and/or local uSIDs of packets. This configuration may be defined by a controller in the network and/or routing protocol advertisements. Responsive to a received packet, a network node identifies and performs the corresponding network slice realization functionality based on slice-representative value(s) provided by one or more global and/or local uSIDs of the destination address of the received packet. Various encodings within an IPv6 Destination Address of the encapsulating packet are disclosed.

### CROSS-REFERENCE TO RELATED APPLICATIONS

This application claims priority to U.S. Provisional Application No. 63/157,810, filed Mar. 7, 2021, which is hereby incorporated by reference in its entirety.

### TECHNICAL FIELD

The present disclosure relates generally to control plane provisioning and data plane transport and processing of packets in a Segment Routing network that includes invoking corresponding network behavior, including, but not limited to, realization of corresponding network slices based Segment Routing segments and/or micro segments.

### BACKGROUND

The communications industry is rapidly changing to adjust to emerging technologies and ever increasing customer demand. This customer demand for new applications and increased performance of existing applications is driving communications network and system providers to employ networks and systems having greater speed and capacity (e.g., greater bandwidth). In trying to achieve these goals, a common approach taken by many communications providers is to use packet switching technology. Packets are typically forwarded in a network based on one or more values representing network nodes or paths.

### BRIEF DESCRIPTION OF THE DRAWINGS

The appended claims set forth the features of one or more embodiments with particularity. The embodiment(s), together with its advantages, may be understood from the following detailed description taken in conjunction with the accompanying drawings of which:

FIG. 1A illustrates a packet switching device according to one embodiment;

FIG. 1B illustrates an apparatus or component thereof according to one embodiment;

FIG. 2A illustrates controller-programmed or node advertised network slice mappings according to one embodiment;

FIG. 2B illustrates link bandwidth network slicing according to one embodiment;

FIG. 2C illustrates a Segment Routing packet according to one embodiment;

FIG. 2D illustrates Segment Routing Identifiers (SIDs) and micro segments (uSIDs) according to one embodiment;

FIG. 3A illustrates a process according to one embodiment;

FIG. 3B illustrates a process according to one embodiment;

FIG. 4 illustrates a network operating according to one embodiment;

FIG. 5A illustrates a network operating according to one embodiment;

FIG. 5B illustrates a network operating according to one embodiment;

FIG. 5C illustrates a network operating according to one embodiment; and

FIG. 5D illustrates a network operating according to one embodiment.

### DESCRIPTION OF EXAMPLE EMBODIMENTS

### 1. Overview

Disclosed are, inter alia, methods, apparatus, computer-storage media, mechanisms, and means associated with control plane provisioning and data plane provisioning, transport, and processing of packets in a network, with Segment Routing Internet Protocol Version 6 (SRv6) Identifiers (SIDs) and/or micro segments (uSIDs) included in packets causing invocation of correspondingly identified network behavior, including, but not limited to, realization of corresponding network slices. In one embodiment, this network behavior includes differential processing by network nodes as designated in associated different SIDs and/or uSIDs.

One embodiment includes a method. A particular Segment Routing node in a network receives a Segment Routing version 6 (SRv6) packet including an Internet Protocol version 6 (IPv6) Destination address that is an address of the particular Segment Routing node, with the IPv6 Destination address including a plurality of micro segments (uSIDs) with a particular uSID of the plurality of uSIDs mapping to a particular Network Slice behavior of a plurality of different Network Slice behaviors performed on different packets by the particular Segment Routing node. The particular Segment Routing node processes said received SRv6 which comprises differential processing the particular SRv6 packet according to the particular Network Slice behavior, with said differential processing being different than processing according to one of the plurality of different Network Slices behaviors that is not the particular Network Slice behavior, updating of the IPv6 Destination Address comprising removing a routing uSID identifying the particular Segment Routing node and shifting into higher-order bit positions one or more uSIDs in the IPv6 Destination Address of said received SRv6 packets; and sending from the particular Segment Routing node the SRv6 packet with said updated IPv6 Destination Address.

One embodiment performs a lookup operation in a Network Slice mapping data structure resulting in identification of the particular Network Slice behavior based on the particular uSID.

In one embodiment, the particular uSID is a combined Per-Hop Behavior (PHB) and routing uSID indirectly identifying the particular Network Slice behavior and is part of an advertised route of the particular Segment Routing node. In one embodiment, the particular uSID is a Per-Hop Behavior (PHB) uSID; wherein the particular uSID concatenated with a first routing uSID is part of an advertised route of the particular Segment Routing node; and wherein said removing the routing uSID includes removing the first routing uSID. In one embodiment, the particular uSID is a Per-Hop Behavior (PHB) uSID; wherein a first routing uSID is part of an advertised route of the particular Segment Routing node; and wherein said removing the routing uSID includes removing the first routing uSID. In one embodiment, the particular uSID is in lower-order bits of the IPv6 Destination address than all routing uSIDs in the IPv6 Destination Address of the received SRv6 packet.

In one embodiment, the IPv6 Destination Address of the received SRv6 packet includes a plurality of pairings of Per-Hop Behavior (PHB) and routing uSIDs; wherein the plurality of pairings includes a particular pairing including the particular uSID and the routing uSID; and wherein said removing the routing uSID includes removing the particular pairing. In one embodiment, the particular pairing is part of an advertised route of the particular Segment Routing node. In one embodiment, the particular pairing includes the particular uSID concatenated with the routing uSID. In one embodiment, the particular pairing includes the routing uSID concatenated with the routing uSID. In one embodiment, the routing uSID is part of an advertised route of the particular Segment Routing node.

In one embodiment, the particular uSID is a global Per-Hop Behavior (PHB) uSID identifying PHB to be performed one or more other Segment Routing nodes in the network. In one embodiment, the particular uSID is part of an advertised route of the particular Segment Routing node. In one embodiment, the IPv6 Destination Address of the received SRv6 packet includes a Flex-Algo uSID; and processing of the packet includes processing according to a Flexible Algorithm identified by the Flex-Algo uSID.

In one embodiment, prior to receiving the SRv6 packet, the particular Segment Routing node configures one or more hardware resources to perform differential processing for each of the plurality of different Network Slice behaviors. In one embodiment, each of the plurality of Network Slice behaviors defines packet processing latency or link bandwidth capacity. In one embodiment, said one or more resources includes queues, ternary content-addressable memories (TCAMs), and/or memory.

### 2. Description

Disclosed are, inter alia, methods, apparatus, computer-storage media, mechanisms, and means associated with control plane provisioning and data plane provisioning, transport, and processing of packets in a network, with Segment Routing Internet Protocol Version 6 (SRv6) Identifiers (SIDs) and/or micro segments (uSIDs) included in Internet Protocol Version 6 (IPv6) Destination Addresses, and possibly in Segment List(s) of a Segment Routing Header. In one embodiment, these uSIDs and SIDs identify different forwarding and processing information that, inter alia, causes network nodes to invoke correspondingly-identified network behavior, including, but not limited to, realization of corresponding network slices. In one embodiment, this network behavior includes differential processing by network nodes as designated in associated different uSIDs and/or SIDs.

Embodiments disclosed herein are typically described using uSID terminology and corresponding processing (e.g., consistent with SRv6 Network Programming, IPv6 Segment Routing Header (SRH), and Compressed SRv6 Segment List Encoding in SRH). As used herein, the terms micro segment, micro segment identifier, micro SID, and uSID are used interchangeably to refer to an embodiment of a Compressed SID (also referred to as a compact SID. The teachings provided herein in relation to uSIDs are applicable to embodiments using other forms of Compressed SIDs and/or compact forwarding identifiers.

As used herein, the terms SRv6 segment identifier, SRv6 SID, SRv6 segment, segment identifier, SID, and segment are used interchangeably to refer to a 128-bit value (e.g., an IPv6 address), that may or may not include a uSID. When one of these terms is qualified by “uSID” (or the like), the SRv6 SID (e.g., a uSID container, a 128-bit value, an IPv6 address) includes one or more uSIDs. A uSID container is sometimes referred to as a uSID carrier.

The terms “node” and “network node” are used herein to refer to a router or host.

The term “route” is used herein to refer to a fully or partially expanded prefix/route (e.g., for IPv4: 10.0.0.1 or 10.0.*.*), which is different than a “path” through the network which refers to a nexthop (e.g., next router) or complete path (e.g., traverse router A then router B, and so on). Also, the use of the term “prefix” without a qualifier herein refers to a fully or partially expanded prefix. The use of the ellipsis (“ . . . ”) identifies that the item might include additional values. The term “concatenate” means to join sequentially in the order identified (e.g., “A” concatenated with “B” means “AB”—not “BA”).

As used herein, “forwarding information” includes, but is not limited to, information describing how to process (e.g., forward, send, manipulate, modify, change, drop, copy, duplicate, receive) corresponding packets. In one embodiment, determining forwarding information is performed via one or multiple lookup operations (e.g., ingress lookup operation(s), an egress lookup operation(s)). Also, the term “processing” when referring to processing of a packet process refers to a broad scope of operations performed in response to a packet, such as, but not limited to, forwarding/sending, dropping, manipulating/modifying/changing, receiving, duplicating, creating, intercepting, consuming, policing, quality of service processing, applying one or more service or application functions to the packet or to the packet switching device (e.g., updating network configuration, forwarding, network, management, operations/administration/management and/or other information), etc. Also, as used herein, the term processing in “parallel” is used in the general sense that at least a portion of two or more operations are performed overlapping in time. The term “interface,” expansively used herein, includes the interface infrastructure (e.g., buffers, memory locations, forwarding and/or other data structures, processing instructions) that is used by a network node in performing processing related to packets. Further, as used herein, a “virtual interface,” in contrast to a “physical interface,” is an interface that does not directly connect to an external electrical or optical cable (e.g., to the cable's terminating interface) or other communications mechanism.

As described herein, embodiments include various elements and limitations, with no one element or limitation contemplated as being a critical element or limitation. Each of the claims individually recites an aspect of the embodiment in its entirety. Moreover, one or more embodiments described include, but are not limited to, inter alfa, systems, networks, integrated circuit chips, embedded processors, ASICs, other hardware components, methods, and computer-readable media containing instructions. In one embodiment, one or more systems, devices, components, etc., comprise the embodiment, which may include some elements or limitations of a claim being performed by the same or different systems, devices, components, etc. when compared to a different one embodiment. In one embodiment, a processing element includes a general processor, task-specific processor, ASIC with one or more processing cores, and/or any other co-located, resource-sharing implementation for performing the corresponding processing. The embodiments described hereinafter embody various aspects and configurations, with the figures illustrating exemplary and non-limiting configurations. Computer-readable media and means for performing methods and process block operations (e.g., a processor and memory or other apparatus configured to perform such operations) are disclosed and are in keeping with the extensible scope of the embodiments. The term “apparatus” is used consistently herein with its common definition of an appliance or device.

The steps, connections, and processing of signals and information illustrated in the figures, including, but not limited to, any block and flow diagrams and message sequence charts, are typically performed in the same or in a different serial or parallel ordering and/or by different components and/or processes, threads, etc., and/or over different connections and be combined with other functions in other embodiments, unless this disables the embodiment or a sequence is explicitly or implicitly required (e.g., for a sequence of read the value, process said read value—the value must be obtained prior to processing it, although some of the associated processing is be performed prior to, concurrently with, and/or after the read operation). Also, nothing described or referenced in this document is admitted as prior art to this application unless explicitly so stated.

The term “one embodiment” is used herein to reference a particular embodiment, wherein each reference to “one embodiment” may refer to a different embodiment. The use of the term “one embodiment” repeatedly herein is used to describe associated features, elements and/or limitations that are included in one or more embodiments, but does not establish a cumulative set of associated features, elements and/or limitations that each and every embodiment must include. Although, one embodiment may include all these features, elements and/or limitations. In addition, the terms “first,” “second,” etc., as well as “particular” and “specific” are used herein to denote different units (e.g., a first widget or operation, a second widget or operation, a particular widget or operation, a specific widget or operation). The use of these terms herein does not connote an ordering such as one unit, operation or event occurring or coming before another or another characterization, but rather provides a mechanism to distinguish between elements units. Moreover, the phrases “based on x,” “in response to x,” “responsive to x” are used to indicate a minimum set of items “x” from which something is derived or caused, wherein “x” is extensible and does not necessarily describe a complete list of items based on which the operation is performed. Additionally, the phrase “coupled to” or “communicatively coupled to” is used to indicate some level of direct or indirect connection between elements and/or devices, with the coupling device or devices modifying or not modifying the coupled signal or communicated information. Moreover, the term “or” is used herein to identify a selection of one or more, including all, of the conjunctive items. Additionally, the transitional term “comprising,” which is synonymous with “including,” “containing,” or “characterized by,” is inclusive/open-ended, and does not exclude additional, unrecited elements, method steps, etc. Finally, the term “particular machine,” when recited in a method claim for performing steps, refers to a particular machine within the 35 USC § 101 machine statutory class.

Segment Routing Internet Protocol Version 6 (SRv6) Network Programming enables the creation of overlays with underlay optimization to be deployed in a Segment Routing (SR) domain. An ingress edge SRv6 network node typically encapsulates a received packet with an outer Internet Protocol Version 6 (IPv6) header and optionally one or more Segment Routing Headers (SRHs). In one embodiment, the Destination Address in the outer IPv6 header includes multiple uSIDs, including global and/or local uSIDs (e.g., used in routing packets and defining processing behavior of packets).

Network slicing provides the ability to partition a physical network into multiple logical networks of varying sizes, structures, and functions so that each slice can be dedicated to specific services or customers. Network slices need to operate in parallel while providing slice elasticity in terms of network resource allocation. The realization of the network slice (e.g., its defined description) is the implementation in the underlying network layers. A network slice's realization is often determined from service requirements and available capabilities of the underlying, typically shared, infrastructure.

Numerous techniques are disclosed herein for encoding of network slices in the IPv6 Destination Address (and possibly in SIDs in a Segment List in a SRH), and subsequent transportation and/or processing of packets according to this encoded, directly or indirectly, network slice. One embodiment includes a network slice value in one or more uSIDs or SIDs representing a corresponding network slice. In one embodiment, the network slice value is a “Slice Identifier” (SLID), such as an 8-bit value uniquely identifying a particular slice in a SR domain. In one embodiment, a network node translates a received uSID or SID into a corresponding mapped network slice value. In one embodiment, a network node translates a received network slice value into a corresponding mapped uSID or SID Per-Hop Behavior (PHB). In one embodiment, the network slice value is used to identify the corresponding network slice Per-Hop Behavior (PHB) in one or more data structures. In one embodiment, a network node translates a received PHB identifier into a corresponding mapped network slice value. In one embodiment, a network node translates a received PHB identifier into a corresponding aggregated network slice value. In one embodiment, a network node translates a received PHB identifier into a local hardware resource identifier on the node.

In one embodiment, network nodes are configured to perform differential network slice realization functionality based on values slice-representative value(s) provided by global and/or local uSIDs of packets. Responsive to a received packet, a network node identifies and performs the corresponding network slice realization functionality based on slice-representative value(s) provided by one or more global and/or local uSIDs of the destination address of the received packet.

Network slicing is used for different use cases, subscriber services, and classes of customers. In one embodiment, for 5G, 6G, and/or other networks, service providers use network slicing technology to deliver Ultra-Reliable Low-Latency Communication (URLLC) services, such as for, but not limited to, tele-medicine, on-line gaming, autonomous connected cars, and many other mission critical applications. To provide these guaranteed services and achieve required Service Level Agreements (SLAs), network resources and network functions in one embodiment are provisioned to ensure there is no (or minimized) degradation due to congestion, faults, maintenance and other issues. In one embodiment, security and privacy guarantees are provided by these services. In one embodiment, processing and storage of the data in the network is a function of the identified network slice.

In one embodiment, Network Slicing is fundamentally an end-to-end partitioning of the network resources and network functions so that selected applications/services/connections run in isolation from each other for a specific business purpose. In a general sense, a network slice refers an overlay infrastructure providing specific network services according specific attributes, objectives, and constraints. In one embodiment, infrastructure comprises every aspect of the network architecture, including radio, transport network, mobile core infrastructure, as well the orchestration infrastructure needed to manage and operate a slice.

In one embodiment, a network slice defines connectivity resource requirements and associated network behaviors such as, but not limited to, bandwidth allocation, latency, jitter, packet loss, availability, security, privacy, hardware queue allocations, deterministic schedulers, hardware and software resource partitioning, and network service functions with other resource behaviors such as compute and storage availability. Each network slice is associated with a set of characteristics and behaviors that separate one type and/or set of flows of user-traffic from another. The networking slice relies on per hop behavior and how the data packet used by the network slice is treated on the node. Different behaviors may be used by the nodes to provide certain guarantees such as bandwidth guarantee or latency bound guarantee. The guarantee is then used by the service provide to provide service level assurance (SLA) for the service offered by the corresponding network slice.

Network slicing related to the network infrastructure typically includes at least some of the following requirements.
Transport slice management, comprising the ability to create, modify, and delete a complete network slice, including any actions required to the transport layer itself. It often includes per-slice Operations, Administration, and Maintenance (OAM) capabilities to allow both the slice application owner and the operator to monitor the health and performance of the slice.
Resource reservation, comprising the ability to reserve transport resources for a transport slice.
Slice isolation, comprising any single transport slice should be isolated from other transport slices at the proper performance, operational, security, and reliability levels that are dictated by the service policy of the application or end user.
Abstraction, comprising the ability to utilize resources to model and build a transport infrastructure suitable for the needs of a slice.

A network slice is sometimes characterized as being a “hard” or “soft” slice based on the level of resource sharing between different slices. In both cases, they typically meet the requirements and/or features outlined above. A network slice that has resources dedicated to it and that are not shared with other slices is considered to be a “hard” slice. For example, a transport layer portion of a network slice may have bandwidth dedicated to it. In contrast, the “soft” slice resources can be shared between slices, while maintaining proper Service Layer Agreement (SLA) and/or other requirements, as well as return the resources to the network when the resources for other uses are no longer needed.

Within the core transport network, Segment Routing provides the means to share resources using shortest path routing and statistical multiplexing combined with DiffSery QoS to create a soft slice. The Differentiated Service (Diffserv) model allows for carrying multiple services on top of a single physical network by relying on compliant nodes to apply specific forwarding treatment (scheduling and drop policy) on to packets that carry the respective Diffsery code point. However, DiffSery cannot discriminate and differentially treat the same type of traffic (e.g., VoIP traffic) coming from different tenants with different SLA requirements, or otherwise perform traffic isolation. In one embodiment, the slice identification is independent of topology and the QoS/DiffSery policy of the network, thus enabling scalable network slicing for SRv6 overlays. In one embodiment, each network slice in an SR domain is uniquely identifiable based on various techniques and encoding described herein.

To create a hard slice in one embodiment, traffic-engineered Segment Routing policies are built using distributed techniques such as Flex-Algo, or centralized techniques such as using Segment Routing Path Computation Engine (SR-PCE) that provide resources entirely dedicated to a specific transport slice.

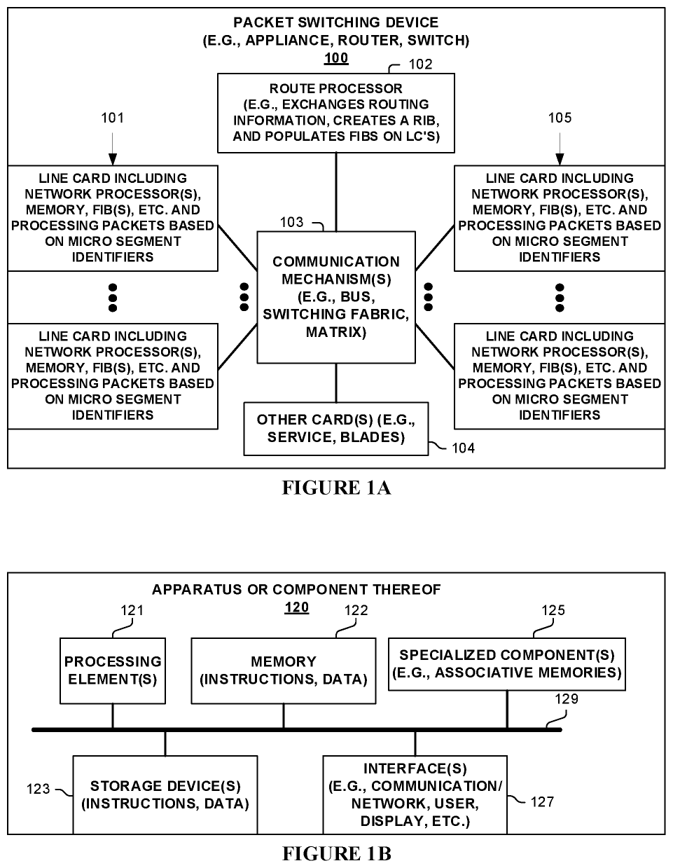

FIGS. 1A-B and their discussion herein are intended to provide a description of various exemplary packet switching systems used in processing packets according to one embodiment. One embodiment processes packets in a network based on SIDs, uSIDs, compressed SIDs, and/or compact forwarding identifiers typically represented in a single 128-bit IPv6 address (e.g., the Destination Address of the outer IPv6 header of a packet). In one embodiment, additional SIDs, uSIDs, Compressed SIDs, and/or compact forwarding identifiers are included in one or more Segment Lists of a SRH.

One embodiment of a packet switching device 100 is illustrated in FIG. 1A. As shown, packet switching device 100 includes multiple line cards 101 and 105, each with one or more network interfaces for sending and receiving packets over communications links, and with one or more processing elements that are used in one embodiment associated with SRv6 SIDs and uSIDs invoking network behavior including realization of network slices, typically represented in a single 128-bit IPv6 address, such as, but not limited to the Destination Address of the outer IPv6 header of a packet.

Packet switching device 100 also has a control plane with one or more processing elements 102 for managing the control plane and/or control plane processing of packets. Packet switching device 100 also includes other cards 104 (e.g., service cards, blades) which include processing elements that are used in one embodiment to process (e.g., forward/send, drop, manipulate, change, modify, receive, create, duplicate, apply a service) packets based on SIDs, uSIDs, Compressed SIDs and/or compact forwarding identifiers; and some hardware-based communication mechanism 103 (e.g., bus, switching fabric, and/or matrix, etc.) for allowing its different entities 101, 102, 104 and 105 to communicate.

Line cards 101 and 105 typically perform the actions of being both an ingress and egress line card, in regards to multiple other particular packets and/or packet streams being received by, or sent from, packet switching device 100.

FIG. 1B is a block diagram of an apparatus 120 used in one embodiment. In one embodiment, apparatus 120 performs one or more processes, or portions thereof, corresponding to one of the flow diagrams illustrated or otherwise described herein, and/or illustrated in another diagram or otherwise described herein.

In one embodiment, apparatus 120 includes one or more processor(s) 121 (typically with on-chip memory), memory 122, storage device(s) 123, specialized component(s) 125 (e.g., optimized hardware such as for performing lookup and/or packet processing operations, associative memory, binary and/or ternary content-addressable memory, etc.), and interface(s) 127 for communicating information (e.g., sending and receiving packets, user-interfaces, displaying information, etc.), which are typically communicatively coupled via one or more communications mechanisms 129 (e.g., bus, links, switching fabric, matrix), with the communications paths typically tailored to meet the needs of a particular application.

Various embodiments of apparatus 120 may include more or fewer elements. The operation of apparatus 120 is typically controlled by processor(s) 121 using memory 122 and storage device(s) 123 to perform one or more tasks or processes. Memory 122 is one type of computer-readable/computer-storage medium, and typically comprises random access memory (RAM), read only memory (ROM), flash memory, integrated circuits, and/or other memory components. Memory 122 typically stores computer-executable instructions to be executed by processor(s) 121 and/or data which is manipulated by processor(s) 121 for implementing functionality in accordance with an embodiment. Storage device(s) 123 are another type of computer-readable medium, and typically comprise solid state storage media, disk drives, diskettes, networked services, tape drives, and other storage devices. Storage device(s) 123 typically store computer-executable instructions to be executed by processor(s) 121 and/or data which is manipulated by processor(s) 121 for implementing functionality in accordance with an embodiment.

One embodiment realizes end-to-end Network Slices using Per-Hop Forwarding Behavior for data packets defined by SRv6 uSID instructions along with Slice Identifiers and their associated slice profiles for each node and/or link along the packet traversal path for ensuring the network wide consistent treatment for each end-to-end network slice. In one embodiment, Per-Hop Behavior SRv6 uSID instructions and the Slice Identifiers are controller-allocated. In one embodiment, Per-Hop Behavior SRv6 uSID instructions and the Slice Identifiers are advertised (e.g., flooded) via a routing protocol (e.g., Interior Gateway Routing Protocol “IGRP”) by nodes of the network.

Data packets carry the Per-Hop Behavior SRv6 uSID instructions, which are used by the forwarding plane (e.g., network nodes along the traversal path) to provide the corresponding treatment in data plane. These SRv6 uSID instructions provide the forwarding state for the packet consistent with Segment Routing architecture.

In one embodiment, a packet does not include the Slice ID, but rather the Per-Hop Behavior SRv6 uSID instructions are mapped to corresponding particular end-to-end Network Slices (e.g., using a level of indirection, that can help improve the scale for number of network slices as many slices can be mapped to one per-hop behavior identifier on a node). In one embodiment, this packet treatment includes, but is not limited to, using low latency queuing, rate limiting, security-level, privacy, storage-function, service function chaining (e.g., firewall), in-situ OAM for proof-of-transit, path tracing, service-assurance, fast-reroute protection, reliability, deterministic scheduling for time-sensitive slice, and/or physical/logical isolation and resource partitioning. In one embodiment, the desired Per Hop Behavior is augmented by Quality of Service processing based on the Traffic Class field, typically including the differentiated services code point (DSCP) field.

In one embodiment, the desired Per Hop Behavior is augmented by Interior Gateway Protocol (IGP) Flexible Algorithm (Flex-Algo). Flex-Algo is typically used to route the data packets on a minimum IGP cost or lowest latency paths in a network. Flex-Algo is not typically suitable to provide PHB treatment that can map a large number of network slices (e.g., one thousand). Network slices may use certain Flex-Algo paths for the data packets. Thus, many network slices may map to certain Flex-Algos. Within the Flex-Algo, the packets carry different PHB instructions to provide different PHBs required by the network slices.

In one embodiment, packets of the same flow use the same PHB uSID instruction in forwarding packets through the network; and hence, are treated uniformly according to equal-cost multi-path (ECMP) routing, especially when using EC1VIP hashing based on the three-tuples of IPv6 Source Address, IPv6 Destination Address, and Flow Label.

In one embodiment, the mapped SLIDs of the Per-Hop Behavior SRv6 uSID instructions are used by a network controller (e.g., software-defined network (SDN) controller) to provide end-to-end SLAs and map to a network service. In one embodiment, the mapped SLIDs of the Per-Hop Behavior SRv6 uSID instructions are used in per-slice Constrained Shortest Path First (CSPF) path computation, performance delay/loss measurement, liveness monitoring and OAM in general, etc.

In one embodiment, the Per-Hop Behavior SRv6 instruction (and its corresponding slice identifier) is used to “stitch” the SRv6/IPv6 network with an MPLS (or other) network to provide an end-to-end multi-domain Network Slice. Upon detecting an issue on a network node, the packet traffic is automatically diverted in the Segment Routing data plane to provide multi-domain matching Per-Hop Behavior in the MPLS (or other) network. One embodiment performs the multi-domain “stitching” from MPLS (or other) network into an SRv6/IPv6 network. In one embodiment, an IPv6 Provider Edge Router (6VPE) maps its IPv6 Per-Hop Behavior to an MPLS core Per-Hop behavior and vice versa.

In one embodiment, per-hop SRv6 uSID instructions (e.g., uSID(s)) are allocated on each hop along each packet path for data plane processing of packets to realize end-to-end network slices and their associated Slice Identifiers (SLIDs). Slice profiles are used by the nodes to configure and provide resource allocation, scheduling/queuing, security, privacy, isolation, and other packet forwarding treatment in the data plane specific to each network slice. One or more uSIDs may be mapped to a same SLID, which provides scalability. In one embodiment, the forwarding fast path of a network node implements only a portion of the different behaviors (e.g., ten different behaviors in a network that supports a thousand different Network Slices that are managed by a network controller in one embodiment). The indirection (e.g., mapping) of PHB instructions (e.g., uSIDs) to implemented Network Slices on a network node provides scalability, as the processing resources required to support the desired PHB is reduced by order(s) of magnitude in one embodiment. In one embodiment, an aggregation of network slices is represented as PHB identifier as an aggregate identifier. In one embodiment, network slices are used as resource partitioning on a node, with PHB on the node identifying the partitioned resources for the network slices.

In one embodiment, network slice Per-Hop Behavior (PHB) is determined based on slice profiles. These slice profiles are configured on network nodes typically with an identifying Slice ID (SLID), name, and properties (such as bandwidth, latency, queues, priority, ACL, etc.). These properties identify the PHB required for implementing the network slice and packet traffic treatment on the node for the corresponding network slice.

The methods are typically described in this document as using a per-hop behavior identifier or the slice identifier in IPv6 destination address field. However, one embodiment includes such an identifier in another field, such as, but not limited to, the IPv6 hop-by-hop option, IPv6 end-to-end option, a type-length value (TLV) in a SRH, or another field in the IPv6 header or in a SRH.

In one embodiment, the IPv6 Destination Address is copied from the Segment List of a SRH of the packet. In this case, the per-hop behavior identifier or the slice identifier instruction is carried in the Segment List of the SRH. In one embodiment, the node processing the outer IPv6 header, also copies the next-hop address and the per-hop behavior instruction from the Segment List of the SRH. In one embodiment, the per-hop behavior is maintained in the IPv6 Destination Address, which is modified with the next-hop routing instruction(s) being copied from a Segment List of a SRH.

In one embodiment, the nodes derive the next-hop destination address from an IPv6 extension header carrying this next-hop information. In one embodiment, the PHB Identifier or slice identifier is also carried in the IPv6 extension header with the next-hop address information.

In one embodiment, the PHB instruction carries an optional a timestamp value (e.g., thirty-two bits encoded similar to the PHB instruction just before or just after the PHB uSID instruction in the IPv6 Destination address Field or at the start or end of the IPv6 destination address) directly or indirectly identifying a deadline or lifetime for the packet in the network. In one embodiment, if this deadline or lifetime is exceeded, the packet is treated differently by the intermediate or egress nodes (e.g., the packet is discarded/dropped by the per-hop behavior on the node). In one embodiment, this behavior is especially useful and/or required in a time-sensitive network (TSN) where the network service cannot tolerate excessive latency.

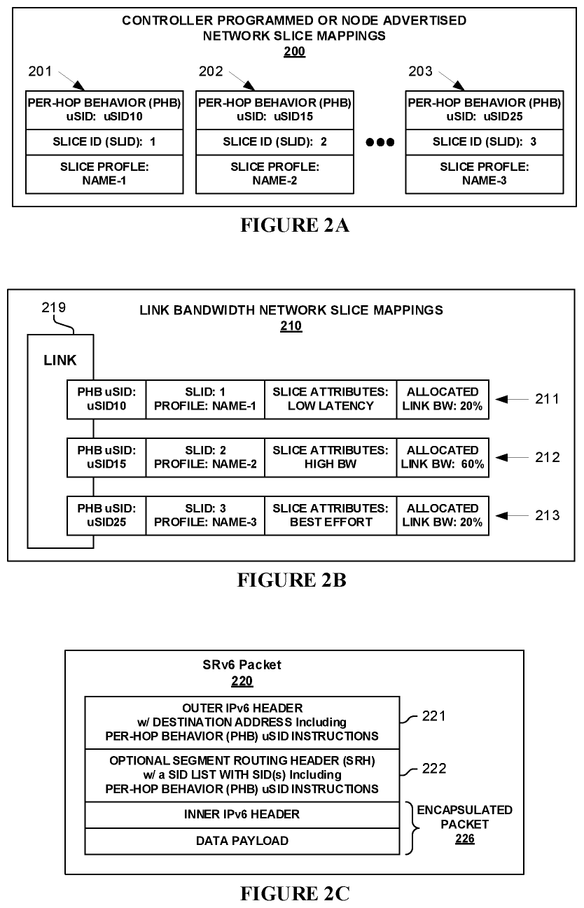

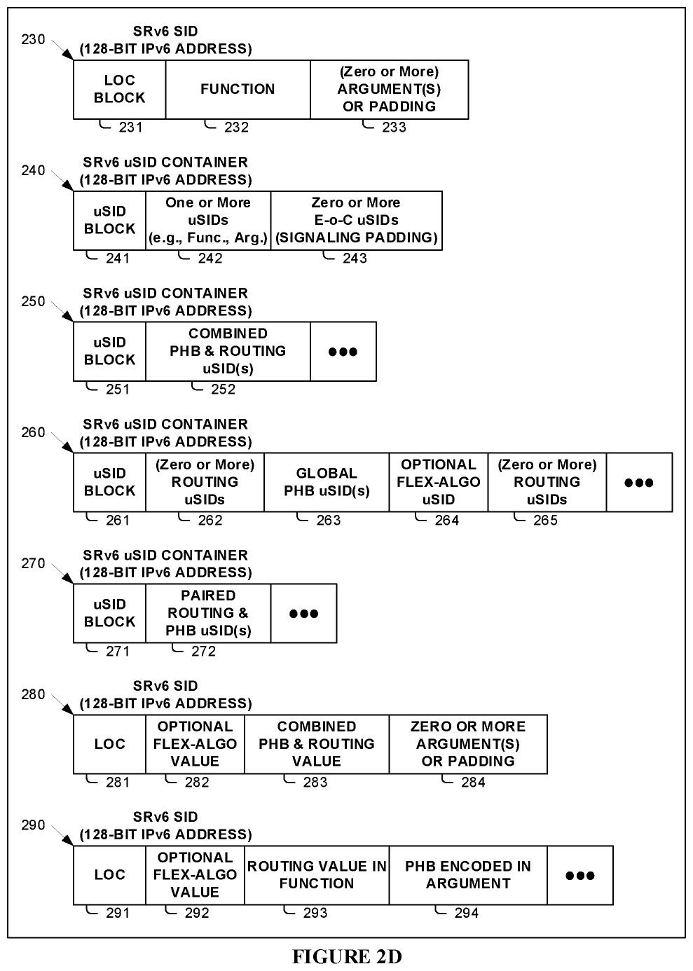

FIG. 2A illustrates controller-programmed or node advertised PHBs based on uSID to SLID mappings (200) according to one embodiment. As shown, each mapping 201-203 includes a uSID mapped to a SLID (e.g., uSID10->SLID 1, uSID15->SLID 2, and uSID25->SLID 3), with each SLID have a corresponding name (e.g., for user ease of identification).

In one embodiment, each network slice has resource allocations and/or guarantees for the network node, such as, but not limited to: link bandwidth capacity, hardware resources (e.g., queues, content-addressable memory entries, memory), hardware queue mappings, network processing unit or co-processor mappings, forwarding table mapping, BCDL (Bulk Code Download of) route update priority, TI-LFA (Topology Independent—Loop Free Alternate) Fast Reroute protection, scheduling, Service Function Chaining, In-Situ Operations, Administration, and Maintenance (iOAM) behaviors such as recording of timestamps and interface/node identifiers, security, reliability, time-sensitivity (e.g., treated as deterministic scheduling in one embodiment), isolation, partitioning, and/or Quality of Service (QoS) application.

In one embodiment, end-to-end specific network functions are enabled for the corresponding Per-Hop behavior. In one embodiment, these network functions include performance monitoring (e.g., delay, or packet loss, through-put), OAM functions, and or service function chaining (SFC). In one embodiment, end-to-end performance is measured for a network slice and provided service by routing one or more performance measurement probe query packets using the same PHB instructions as used for customer data traffic. In one embodiment, the identified performance measurement attributes are collected and published to a network controller (e.g., by a provider edge node). Using uSIDs in implementing the PHB along a particular path through the network provides advantages over prior networks by providing end-to-end performance measurements of a network slice.

FIG. 2B illustrates bandwidth network slice mappings 210 of a link 219 according to one embodiment. As shown, each mapping 211-213 includes a uSID mapped to a SLID (e.g., uSID10->SLID 1, uSID15->SLID 2, and uSID25->SLID 3), with each SLID have a corresponding name (e.g., for user ease of identification), slice latency attributes (e.g., low latency, high bandwidth, best effort), and allocated bandwidth (e.g., twenty percent, sixty percent).

In one embodiment, the network SLID for each link is advertised (e.g., flooded) using a routing protocol (e.g., IGP, BGP-LS). Path computation is performed per network slice by an ingress network node or controller using the SLID for each link. When assigned by the individual network nodes, a corresponding uSID is advertised with a SLID for each link in one embodiment.

FIG. 2C illustrates an SRv6 packet 220 including uSIDs in implementing the PHB along a particular path through the network according to one embodiment. As shown, outer IPv6 header 221 includes an IPv6 Destination Address including Per-Hop Behavior (PHB) uSID instructions, optional Segment Routing Header (SRH) 222, and encapsulated packet 226 being transported through the network according to PHB based on uSIDs and/or SIDs included in the Outer IPv6 Header 221 and optional SRH 222 (if present).

In one embodiment, the IPv6 Destination Address in outer IPv6 header 221 includes all uSIDs required for defining the PHB implementing the end-to-end network slice along the desired forwarding path. Hence, in one embodiment, SRv6 packet 220 does not include optional Segment Routing Header (SRH) 222. In one embodiment, SRv6 packet 220 includes the optional Segment Routing Header (SRH) 222, with the IPv6 Destination Address in a Segment List and/or carries other information in fields of the SRH 222.

In one embodiment, the IPv6 Destination Address in outer IPv6 header 221 does not include all uSIDs required for defining the PHB implementing the end-to-end network slice along the desired forwarding path. Hence, in one embodiment, SRv6 packet 220 includes optional Segment Routing Header (SRH) 222 comprising one or more SIDs including one or more uSIDs (e.g., in addition to the uSIDs in the IPv6 Destination Address) cumulatively defining the PHB implementing the end-to-end network slice along the desired forwarding path. In one embodiment, the Segment Routing processing of SRv6 packet 200 by a network node includes updates the IPv6 Destination Address in the outer IPv6 header 220 of SRv6 packet 200 to that of the next SID in a Segment List of a SRH 222 when the IPv6 Destination Address does not include a Next uSID (e.g., all uSIDs after the Active uSID are E-o-C uSIDs). In one embodiment, this optional Segment Routing Header (SRH) 222 also includes the IPv6 Destination Address in a SID List and/or carries other information in fields of SRH 222.

FIG. 2D illustrates SIDs and uSIDs (e.g., in a 128-bit uSID containers) used in processing (including forwarding) of packets in a network, including uSIDs and SIDs that invoke Per-Hop Behavior (PHB) according to various one embodiments.

SRv6 is a Segment Routing flavor that implements source routing in an IPv6 data plane. As shown, an SRv6 segment (SID) 230 is represented as a 128-bit SID address, including a Locator portion (block) 231 (e.g., a highest-order block of bits), a function portion 232, and ARG portion 233 for optional arguments and/or padding. A first SID is the IPv6 Destination Address of the outer IPv6 header of a SRv6 packet; and if present, additional SID(s) are carried in a Segment List of a Segment Routing Header (SRH) (i.e., an IPv6 extension header). A SID is of topological (e.g., Internet Gateway Protocol IGP)) or service (e.g., Virtual Private Network (VPN), Network Function Virtualization (NFV)) type.

In one embodiment, one or more SRv6 micro segments (uSIDs) are encoded in a single SID (e.g., 128-bit IPv6 address). As shown, uSID container 240 includes a uSID block 241 (e.g., IPv6 prefix), followed by one or more uSIDs 242, with any remaining portion of uSID container 240 populated with End-of-Container (E-o-C) uSID(s) 243 (e.g., 0x0000) or padding bits. In one embodiment, when all of the desired uSIDs fit within a single IPv6 address (e.g., uSID container 240), a SRH is not included in the SRv6 packet. One embodiment uses uSIDs in a manner that leverages benefits of IP, such as, but not limited to, longest prefix matching forwarding, prefix summarization, identifying entropy, etc.

FIG. 2D further illustrates some of an extensible number of variations of the semantics of particular uSIDs within a uSID containers 250-270 and particular SIDs 280-290 according to various one embodiments.

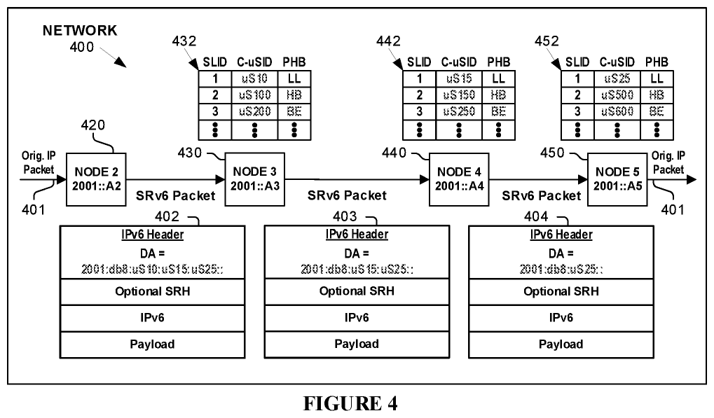

As shown, uSID container 250 comprises a uSID block 251 (e.g., IPv6 prefix) followed by one or more combined PHB and routing uSIDs 252, with each uSID identifying both particular PHB (e.g., operating according to the corresponding network slice) by a particular node and used in forwarding the packet to the particular node. In one embodiment, a prefix comprising the uSID block and the highest-order uSID 252 is an advertised address of a network node that will perform the PHB identified based on to the highest-order uSID 252. One embodiment using such uSIDs defining PHB and network routing is described infra in relation to FIG. 4. In one embodiment, a uSID indirectly identifies a corresponding slice identifier (SLID).

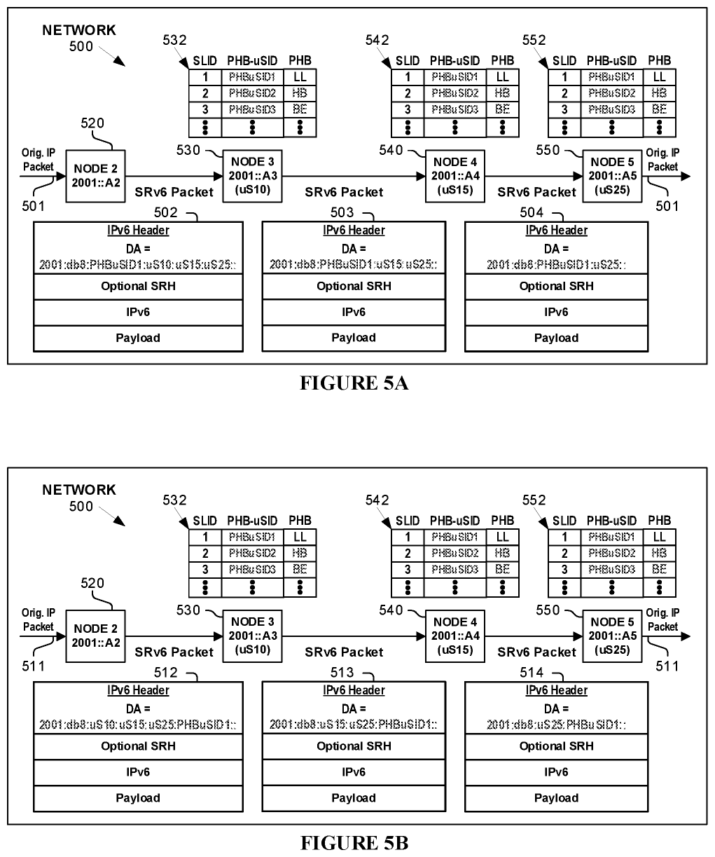

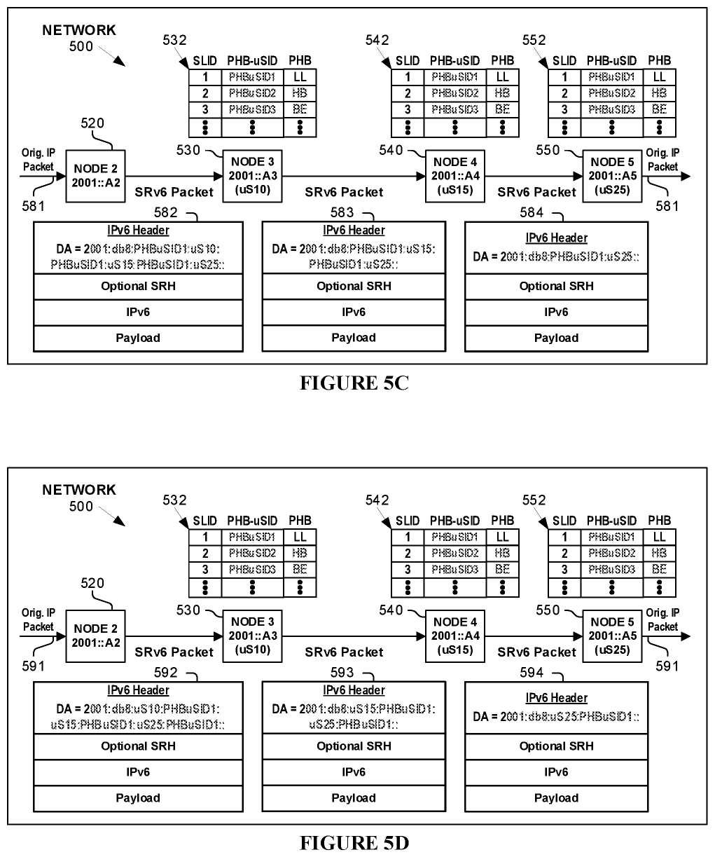

As shown, uSID container 260 comprises a uSID block 261 (e.g., IPv6 prefix) and one or more global Per-Hop Behavior (PHB) uSIDs 263 located in different positions within uSID container 260 according to a corresponding one embodiment. A global SRv6 PHB uSID identifies PHB to be performed on a SRv6 packet by at least SRv6 nodes identified by a routing uSID (262, 265) in uSID container 260. In one embodiment, global PHB uSID 263 immediately follows uSID block 261 (e.g., having zero forwarding uSIDs 262 and one or more routing uSIDs 265), with a corresponding embodiment described infra in relation to FIG. 5A. In one embodiment, global PHB uSID 263 is located after one or more routing uSIDs 262 following uSID block 261 in uSID container 260, with a corresponding embodiment described infra in relation to FIG. 5B. In one embodiment, uSID container 260 includes a uSID 264 identifying a particular Flexible Algorithm (Flex-Algo) to be used in processing the packet in the network. As shown, uSID container 270 comprises a uSID block 271 (e.g., IPv6 prefix) and one or more paired routing and PHB uSIDs 272. In one embodiment, a pairing 272 is a routing uSID followed by a PHB uSID, with a corresponding embodiment described infra in relation to FIG. 5C. In one embodiment, a pairing 272 is a PHB uSID followed by a routing uSID, with a corresponding embodiment described infra in relation to FIG. 5D.

As shown, SID 280 includes locator (LOC) 281, a combined PHB and routing value 283 (e.g., in the SR function (FUNCT) portion of SID 280), and zero or more arguments or padding 284 (e.g., in the SR argument (ARG) portion of SID 280). In one embodiment, SID 280 includes a Flex-Algo value 282 (e.g., in the SR function (FUNCT) portion of SID 280) identifying a particular Flexible Algorithm (Flex-Algo) to be used in processing the packet in the network.

As shown, SID 290 includes locator (LOC) 291, a routing value 293 in the SR function (FUNCT) portion of SID 290, and a PHB value 294 encoded in argument (ARG) portion of SID 290. In one embodiment, SID 290 includes a Flex-Algo value 292 (e.g., in the SR function (FUNCT) portion of SID 290) identifying a particular Flexible Algorithm (Flex-Algo) to be used in processing the packet in the network.

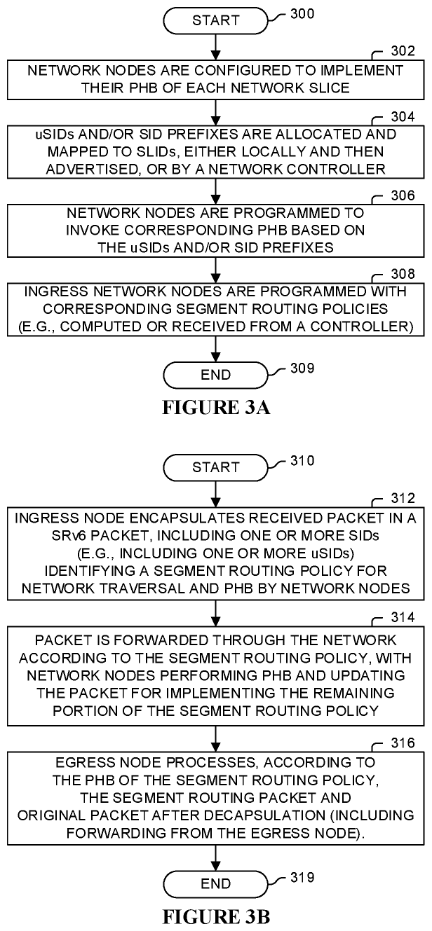

FIG. 3A illustrates a process according to one embodiment. Processing begins with process block 300. In process block 302, the nodes in the network are configured to implement their PHB of each network slice, each associated with a SLID. In one embodiment, each network slice has resource allocations and/or guarantees for the network node, such as, but not limited to: link bandwidth capacity, hardware resources (e.g., queues, content-addressable memory entries, memory), hardware queue mappings, network processing unit or co-processor mappings, forwarding table mapping, BCDL (Bulk Code Download of) route update priority, TI-LFA (Topology Independent—Loop Free Alternate) Fast Reroute protection, scheduling, Service Function Chaining, In-Situ

Operations, Administration, and Maintenance (iOAM) behaviors such as recording of timestamps and interface/node identifiers, security, reliability, time-sensitivity (e.g., treated as deterministic scheduling in one embodiment), isolation, partitioning, and/or Quality of Service (QoS) application. In process block 304, uSIDs and/or SID prefixes are allocated and mapped to SLIDs, either locally and then advertised by the network nodes (e.g., using an IGP Flood Record TLV) and/or by a network controller (e.g., software-defined network (SDN) controller). In process block 306, the network nodes are programmed to invoke corresponding PHB (e.g., forwarding behavior according to a network slice) based on the uSID and/or SID prefixes. In process block 308, ingress network nodes are programmed with corresponding Segment Routing policies (e.g., defined by the ordered SIDs and/or uSIDs) to cause desired path forwarding and PHB on network nodes. In one embodiment, these Segment Routing policies are computed by the individual the ingress network nodes based on received advertisements of SIDs/uSIDs and their associated SLIDs. In one embodiment, a network controller allocates the SIDs/uSIDs and their associated SLIDs, computes the Segment Routing policies, and programs the individual the ingress network nodes to corresponding apply the Segment Routing policy to received packets. Processing of the flow diagram of FIG. 3A is complete as indicated by process block 309.

FIG. 3B illustrates a process according to one embodiment. Processing begins with process block 310. In process block 312, a corresponding Segment Routing policy is applied to received packet (e.g., based on packet classification) by an ingress node, which typically includes encapsulating the received packet in a SRv6 packet, including one or more SIDs (e.g., each possibly including one or more uSIDs) defining PHB applied to the encapsulating SRv6 packet by network nodes traversed according to the computed path through the network. In one embodiment, the SRv6 packet does not include SLID(s), but rather includes SID/uSID per-hop behavior instructions that map to a particular end-to-end network slice (e.g., as a method of indirection). In one embodiment, specific Per-Hop Behavior may be tied to one or more end-to-end network slices.

In process block 314, the SRv6 packet is forwarded through the network to an egress node according to the Segment Routing policy, with network nodes performing their respective PHB identified by (active) SIDs/uSIDs, with the IPv6 Destination Address in the outer header (and possibly a Segment Routing header) of the SRv6 packet typically being updated for implementing the remaining portion of the segment routing policy (e.g., including traversal to the next network node). In one embodiment, the ingress line card of the network node determines the associated SLID based on the active PHB SRv6 uSID instruction of the received packet. The SLID is used to provide the forwarding behavior to the packet and is programmed in hardware based on the local slice profile configured for the link where the packet is received. In one embodiment and responsive to an identified case of a failure, packets with specific PHB may be fast rerouted to another matching PHB.

In one embodiment, the end-to-end forwarding behavior (e.g., Segment Routing policy) provides Layer 3 Virtual Private Network (L3VPN) and/or Ethernet Virtual Private Network (EVPN) Services. In one embodiment, a same network slice is associated with multiple Virtual Private Networks (VPNs) with common service-assurance requirements, and are mapped to the same PHB/Segment Routing policy. In one embodiment, VPNs with different requirements are carried in different network slices, and are mapped to different PHBs/Segment Routing policies.

In process block 316, the egress node processes, according to the PHB of the segment routing policy identified by the (active) SIDs/uSIDs, the received SRv6 packet and the original packet after decapsulation, with this processing typically including forwarding the decapsulated original packet from the egress node according to its corresponding PHB.

Processing of the flow diagram of FIG. 3B is complete as indicated by process block 319.

FIG. 4 illustrates a network 400 operating according to one embodiment. As shown, network 400 includes: ingress node 2 (420) programmed to apply the Segment Routing PHB policy identified in the Destination Address of SRv6 packet 402; intermediate node 3 (430) programmed with Network Slice Mapping Table 432; intermediate node 4 (440) programmed with Network Slice Mapping Table 442; and egress node 5 (450) programmed with Network Slice Mapping Table 452. Each of the uSIDs in each of mapping tables 432, 442, and 452 identify both (a) an address of the corresponding network node 430, 440 and 450, and (b) its corresponding SLID 1 (low latency (LL) slice), SLID 2 (high bandwidth (FIB) slice), SLID 3 (best effort (BE) slice), etc. As such, advertised addresses of network node 3 (430) include prefixes (2001:db8:uS10::), (2001:db8:uS100::), and (2001:db8:uS200::); advertised addresses of network node 4 (440) include prefixes (2001:db8:uS15::), (2001:db8:uS150::), and (2001:db8:uS250::); and advertised addresses of network node 5 (450) include prefixes (2001:db8:uS25::), (2001:db8:uS500::), and (2001:db8:uS600::).

With particular reference to packets 402-404 shown in FIG. 4, its IPv6 Destination Address (and/or SID in a Segment List in a SRH) comprises a uSID container including a uSID Block (2001:db8:) followed by one or more combined PHB and routing uSIDs (identifying both the traversal order of nodes of network 500 and their corresponding PHB applied to the packet) followed by (::) (e.g., zero or more E-o-C uSIDs, each typically having the value of 0x0000).

As shown in FIG. 4, network node 2 (420) receives and processes original IP packet 401 including apply the corresponding Segment Routing Policy (e.g., encapsulates original packet 401 in a Segment Routing packet 402 including the illustrated IPv6 Destination Address) to cause desired transmission and end-to-end low-latency PHB through network 400 via network nodes 430, 440, and 450.

In one embodiment, this processing by network node 2 (420) includes generating SRv6 packet 402 with the corresponding end-to-end PHB and routing uSID SRv6 policy (2001:db8:uS10:uS15:uS25::) in the Destination Address of SRv6 packet 402, and (low latency) correspondingly sending into network 400 SRv6 packet 402 with the IPv6 Destination Address of (2001:db8:uS10:uS15:uS25::).

SRv6 packet 402 is forwarded, based on its IPv6 Destination Address, to network node 3 (430). Based on this IPv6 Destination Address ((2001:db8:uS10:uS15:uS25::) having the Active uSID of uS10, network node 3 (430) identifies the PHB of low latency (SLID 1) via a lookup operation in Network Slice Mapping Table 432. This low latency processing includes generating SRv6 packet 403 by updating of the IPv6 Destination Address of received packet 402 by removing the Active uSID and shifting the remaining uSIDs and adding an E-o-C uSID in the low-order bits, and (low latency) correspondingly sending into network 400 SRv6 packet 403 with the IPv6 Destination Address of (2001:db8:uS15:uS25::).

SRv6 packet 403 is forwarded, based on its IPv6 Destination Address, to network node 4 (440). Based on this IPv6 Destination Address (2001:db8:uS15:uS25::) having the Active uSID of uS15, network node 4 (440) identifies the PHB of low latency (SLID 1) via a lookup operation in Network Slice Mapping Table 442. This low latency processing includes generating SRv6 packet 404 by updating of the IPv6 Destination Address of received packet 403 by removing the Active uSID and shifting the remaining uSID and adding an E-o-C uSID in the low-order bits, and (low latency) correspondingly sending into network 400 SRv6 packet 404 with the IPv6 Destination Address of (2001:db8:uS25::).

SRv6 packet 404 is forwarded, based on its IPv6 Destination Address, to network node 5 (450). Based on this IPv6 Destination Address (2001:db8:uS25::) having the Active uSID of uS25, network node 5 (450) identifies the PHB of low latency (SLID 1) via a lookup operation in Network Slice Mapping Table 452. This low latency processing includes decapsulating and (low latency) correspondingly sending into network 400 original IP packet 401.

Each of FIGS. 5A-5D illustrate network 500 operating according to a corresponding one embodiment. As shown in each of FIGS. 5A-D, network 500 includes: ingress node 2 (520) programmed to apply the Segment Routing PHB policy identified in the Destination Address of a corresponding sent SRv6 packet (502, 512, 582, 592); intermediate node 3 (530) programmed with Network Slice Mapping Table 532; intermediate node 5 (540) programmed with Network Slice Mapping Table 542; and egress node 5 (550) programmed with Network Slice Mapping Table 552.

In one embodiment, a network controller (e.g., SDN controller) provisions each node with the SRv6 PHB uSID instructions (e.g., the particular global uSID) and their matching slice IDs and slice profiles. In one embodiment, the network controller allocates and causes programming of mapping tables 532, 542, and 552 to provide per-hop behavior (PHB) at each node that can help realize end-to-end network slice. In one embodiment, the provisioned and installed uSIDs in each of mapping tables 532, 542, and 552 include global uSIDs: PHBuSID1: mapped to SLID 1 (low latency (LL) slice), PHBuSID2 mapped to SLID 2 (high bandwidth (HB) slice), and PHBuSID3 mapped to SLID 3 (best effort (BE) slice), etc.

In one embodiment, the global uSIDs programmed in mapping tables 532, 542, 552 identify the slice behavior to be performed on the packet, with additional routing uSIDs included in the uSID containers (e.g., IPv6 Destination Address, SID) to identify the ordered forwarding among Segment Routing nodes in network 500. Each of FIGS. 5A-D illustrate different one embodiments using PHB uSIDs (identifying slice behavior) and routing uSIDs (identify the ordered forwarding among Segment Routing nodes in network 500).

FIG. 5A illustrates a network 500 operating according to one embodiment with the global PHB uSID(s) appearing in higher-order bits than the routing uSIDs in a uSID container. By separating the PHB and routing functionality into different uSIDs, one embodiment uses different combinations of routing uSIDs and PHB uSIDs. Thus, in one embodiment, a same routing uSID can be used for routing a packet to a node while applying different PHBs (e.g., that identified in a global PHB uSID).

With particular reference to packets 502-504 shown in FIG. 5A, its IPv6 Destination Address (and/or SID in a Segment List in a SRH) comprises a uSID container including a uSID Block (2001:db8:) followed by global PHB uSID(s) (identifying the end-to-end behavior to be performed on the packet), followed by one or more uSIDs (identifying the traversal order of nodes of network 500) followed by (::) (e.g., zero or more E-o-C uSIDs, each typically having the value of Ox0000).

In one embodiment, the advertised addresses of network nodes 530-550 are of the format: (uSIDBlock:globalPHBuSID:RoutinguSIDofNetworkNode::). In one embodiment, the advertised addresses of network node 3 (530) include prefixes (2001:db8:PHBuSID1:uS10::), (2001:db8:PHBuSID2:uS10::), and (2001:db8:PHBuSID3:uS10::). In one embodiment, the advertised addresses of network node 4 (540) include prefixes (2001:db8:PHBuSID1:uS15::), (2001:db8:PHBuSID2:uS15::), and (2001:db8:PHBuSID3:uS15::). In one embodiment, the advertised addresses of network node 5 (550) include prefixes (2001:db8:PHBuSID1::uS25::), (2001:db8:P1-113uSID2:uS25::), and (2001:db8:PHBuSID3:uS25::).

As shown in FIG. 5A, network node 2 (520) receives and processes original IP packet 501 including apply the corresponding Segment Routing Policy (e.g., encapsulates original packet 501 in a Segment Routing packet 502 including the illustrated IPv6 Destination Address) to cause desired transmission and end-to-end low-latency PHB through network 500 via network nodes 530, 540, and 550.

In one embodiment, this processing by network node 2 (520) includes generating SRv6 packet 502 with the corresponding end-to-end PHB uSID SRv6 policy (2001:db8::PHBuSID1:uS10:uS15:uS25::) in the Destination Address of SRv6 packet 502, and (low latency) correspondingly sending into network 500 SRv6 packet 502 with the IPv6 Destination Address of (2001:db8:PHBuSID1:uS10:uS15:uS25::).

SRv6 packet 502 is forwarded, based on its IPv6 Destination Address, to network node 3 (530). Based on the IPv6 Destination Address (2001:db8:PHBuSID1:uS10:uS15:uS25::) having the Active uSID of uS10, network node 3 (530) identifies the PHB of low latency (SLID 1) via a lookup operation in Network Slice Mapping Table 532 based on PHBuSID1. This low latency processing includes generating SRv6 packet 503 by updating of the IPv6 Destination Address of received packet 502 by removing the Active uSID and shifting the remaining uSIDs and adding an E-o-C uSID in the low-order bits, and (low latency) correspondingly sending into network 500 SRv6 packet 503 with the IPv6 Destination Address of (2001:db8:PEIBuSID1:uS15:uS25::).

SRv6 packet 503 is forwarded, based on its IPv6 Destination Address, to network node 5 (540). Based on the IPv6 Destination Address (2001:db8:PHBuSID1:uS15:uS25::) having the Active uSID of uS15, network node 5 (540) identifies the PHB of low latency (SLID 1) via a lookup operation in Network Slice Mapping Table 542 based on PliBuSID1 . This low latency processing includes generating SRv6 packet 504 by updating of the IPv6 Destination Address of received packet 503 by removing the Active uSID and shifting the remaining uSID and adding an E-o-C uSID in the low-order bits, and (low latency) correspondingly sending into network 400 SRv6 packet 504 with the IPv6 Destination Address of (2001:db8:PHBuSID1:uS25::).

SRv6 packet 504 is forwarded, based on its IPv6 Destination Address, to network node 5 (550). Based on this IPv6 Destination Address ((2001:db8:PHBuSID1:uS25::) having the Active uSID of uS25, network node 5 (550) identifies the PHB of low latency (SLID 1) via a lookup operation in Network Slice Mapping Table 552 based on PHBuSID1. This low latency processing includes decapsulating and (low latency) correspondingly sending into network 500 original IP packet 501.

FIG. 5B illustrates a network 500 operating according to one embodiment with the global PHB uSID(s) appearing immediately following the routing uSIDs in a uSID container. By separating the PHB and routing litnctionality into different uSIDs, one embodiment uses different combinations of routing uSIDs and PHB uSIDs. Thus, in one embodiment, a same routing uSID can be used for routing a packet to a node while applying different PHBs (e.g., that identified in a global PHB uSID).

With particular reference to packet 512 shown in FIG. 5B, its IPv6 Destination Address (and/or SID in a Segment List in a SRH) comprises a uSID container including a uSID Block (2001:db8) followed by one or more one or more uSIDs (corresponding to Segment Routing nodes 530, 540, 550 for traversal of packet 512. 513, 514 through network 500) followed by one or more global PHB uSID (identifying the end-to-end behavior to be performed on the packet), followed by zero or more E-o-C, uSIDS

As such, the advertised addresses of network nodes 530-550 are typically of the format: (uSIDBlock:RoutinguSIDofNetworkNode::). In one embodiment, an advertised address of network node 3 (530) includes the prefix (2001:db8:uS10::). In one embodiment, an advertised address of network node 4 (540) includes the prefix (2001:db8:uS15::). In one embodiment, an advertised address of network node 5 (550) includes the prefix (2001:db8:uS25::).

As shown in FIG. 5B, network node 2 (520) receives and processes original IP packet 511 including apply the corresponding Segment Routing Policy (e.g., encapsulates original packet 511 in a Segment Routing packet 512 including the illustrated IPv6 Destination Address) to cause desired transmission and end-to-end low-latency PHB through network 500 via network nodes 520, 530, and 540. This processing by network node 2 includes generating SRv6 packet 512 with the corresponding end-to-end PHB uSID SRv6 policy (2001:db8:uS10:uS18:uS25:PHBUSID1::) in the Destination Address of SRv6 packet 512, and (low latency) correspondingly sending into network 500 SRv6 packet 512 with the IPv6 Destination Address of (2001:db8:uS10:uS18:uS25:PHBuSID1::).

SRv6 packet 512 is forwarded, based on its IPv6 Destination Address, to network node 3 (530). Based on the IPv6 Destination Address (2001 :db8:uS10:1615:1625:PliBLISID1 ::) having the Active uSID of uS10, network node 3 (530) identifies the PHB of low latency (SLID 1) via a lookup operation in Network Slice Mapping Table 532 based on 1³1⁻1BuSID1. This low latency processing includes generating SRv6 packet 513 by updating of the IPv6 Destination Address of received packet 512 by removing the Active uSID and shifting the remaining uSIDs and adding an E-o-C uSID in the low-order bits, and (low latency) correspondingly sending into network 500 SRv6 packet 513 with the IPv6 Destination Address of (2001:68:uS15:1625:PliBuSID1 ::).

SRv6 packet 513 is forwarded, based on its IPv6 Destination Address, to network node 5 (540). Based on the IPv6 Destination Address (2001:u.S15:uS25:PliBuSID1::) having the Active uSID of uS15, network node 4 (540) identifies the PHB of low latency (SLID 1) via a lookup operation in Network Slice Mapping Table 542 based on PHBuSID1. This low latency processing includes generating SRv6 packet 514 by updating of the IPv6 Destination Address of received packet 513 by removing the Active uSID and shifting the remaining uSID and adding an E-o-C uSID in the low-order bits, and (low latency) correspondingly sending into network 400 SRv6 packet 514 with the IPv6 Destination Address of (2001:db8:uS15:uS25:PHBuSID1::).

SRv6 packet 514 is forwarded, based on its IPv6 Destination Address, to network node 5 (550). Based on this IPv6 Destination Address (2001:db8:uS25:PHBuSID1::) having the Active uSID of uS25, network node 5 (550) identifies the PHB of low latency (SLID 1) via a lookup operation in Network Slice Mapping Table 552 based on PHBuSID 1. This low latency processing includes decapsulating and (low latency) correspondingly sending into network 500 original IP packet 511. Each of FIGS. 5C-5D illustrate network 500 operating according to a corresponding one embodiment wherein a uSID container includes pairings of routing and PHB uSIDs. For ease of illustration purposes, global PHB uSIDs are used; hence mapping tables 532, 542, and 552 are illustrated as having the same mappings. In one embodiment, local PHB uSIDs are used one embodiment of each of FIGS. 5C-5D to designate individual PHB performed on a packet by each of the individual nodes of network 500.

FIG. 5C illustrates one embodiment using the ordered pairing of <PHB uSID, routing uSID>.

With particular reference to packets 582-584 shown in FIG. 5C, its IPv6 Destination Address (and/or SID in a Segment List in a SRH) comprises a uSID container including a uSID Block (2001:db8:) followed by one or more ordered pairings of <PHB uSID, routing uSID>(identifying node traversal order and PHB to be applied by the corresponding node), followed by (::) (e.g., zero or more E-o-C uSIDs, each typically having the value of 0x0000). In one embodiment, the advertised addresses of network nodes 530-550 are of the format: (uSIDBlock:globalPHBuSID:RoutinguSIDofNetworkNode::). In one embodiment, the advertised addresses of network node 3 (530) include prefixes (2001:db8:PHBuSID1:uS10::), (2001:db8:PHBuSID2:uS10::), and (2001:db8:PHBuSID3:uS10::). In one embodiment, the advertised addresses of network node 4 (540) include prefixes (2001:db8:PHBuSID1:uS15::), (2001:db8:PHBuSID2:uS15::), and (2001:db8:PHBuSID3:uS15::). In one embodiment, the advertised addresses of network node 5 (550) include prefixes (2001:db8:PHBuSID1:uS25::), (2001:db8:PHBuSID2:uS25::), and (2001:db8:PHBuSID3:uS25::).

As shown in FIG. 5C, network node 2 (520) receives and processes original IP packet 581 including apply the corresponding Segment Routing Policy (e.g., encapsulates original packet 581 in a Segment Routing packet 582 including the illustrated IPv6 Destination Address) to cause desired transmission PHB through network 500 via network nodes 530, 540, and 550.

In one embodiment, this processing by network node 2 (520) includes generating SRv6 packet 582 with the corresponding end-to-end PHB uSID SRv6 policy (2001:db8:PHBuSID1:uS10:PHBuSID1:uS15:PHBuSID1:uS25::) in the Destination Address of SRv6 packet 582, and (low latency) correspondingly sending into network 500 SRv6 packet 582 with the IPv6 Destination Address of (2001:db8:PHBuSID1:uS10:PHBuSID1:uS15:PHBuSID1:uS25::).

SRv6 packet 582 is forwarded, based on its IPv6 Destination Address (2001:db8:PHBuSID1:uS10:PHBuSID1:uS15:PHBuSID1:uS25::), to network node 3 (530). Network node 530 receives SRv6 packet 582, which includes the Active uSID ordered pairing of <PHBuSID1, uS10>. Based on PHBuSID1:, network node 3 (530) identifies the PHB of low latency (SLID 1) via a lookup operation in Network Slice Mapping Table 532. This low latency processing includes generating SRv6 packet 583 by updating of the IPv6 Destination Address of received packet 582 by removing the uSIDs in the Active uSID ordered pairing and shifting the remaining uSIDs and adding an E-o-C uSID in the low-order bits, and (low latency) correspondingly sending into network 500 SRv6 packet 583 with the IPv6 Destination Address of (2001:db8:PHBuSID1:uS15:PHBuSID1:uS25::).

SRv6 packet 583 is forwarded, based on its IPv6 Destination Address (2001:db8:PHBuSID1:uS15:PHBuSID1:uS25::) to network node 4 (540). Network node 540 receives SRv6 packet 583, which includes the Active uSID ordered pairing of <PHBuSID1, uS15>. Based on PHBuSID1:, network node 4 (540) identifies the PHB of low latency (SLID 1) via a lookup operation in Network Slice Mapping Table 542. This low latency processing includes generating SRv6 packet 584 by updating of the IPv6 Destination Address of received packet 583 by removing the uSIDs in the Active uSID ordered pairing and shifting the remaining uSIDs and adding an E-o-C uSID in the low-order bits, and (low latency) correspondingly sending into network 500 SRv6 packet 584 with the IPv6 Destination Address of (2001:db8:PHBuSID1:uS25::).

SRv6 packet 584 is forwarded, based on its IPv6 Destination Address (2001:db8:PHBuSID1:uS25::) to network node 5 (550). Network node 550 receives SRv6 packet 584, which includes the Active uSID ordered pairing of <PHBuSID1, uS25>. Based on PHBuSID1:, network node 5 (550) identifies the PHB of low latency (SLID 1) via a lookup operation in Network Slice Mapping Table 552. This low latency processing includes decapsulating and (low latency) correspondingly sending into network 500 original IP packet 581.

FIG. 5D illustrates one embodiment using the ordered pairing of <routing uSID, PHB uSID>.

With particular reference to packets 592-594 shown in FIG. 5D, its IPv6 Destination Address (and/or SID in a Segment List in a SRH) comprises a uSID container including a uSID Block (2001:db81) followed by one or more ordered pairing of <routing uSID, PHB uSID>(identifying node traversal order and PHB to be applied by the corresponding node), followed by (::) (e.g., zero or more E-o-C uSIDs, each typically having the value of 0x0000).

In one embodiment, the advertised addresses of network nodes 530-550 are of the format: (uSIDBlock:RoutinguSIDofNetworkNode:). In one embodiment, an advertised address of network node 3 (530) includes the prefix (2001:db8:uS10::). In one embodiment, an advertised address of network node 4 (540) includes the prefix (2001:db8:uS15::). In one embodiment, an advertised address of network node 5 (550) includes the prefix (2001:db8:uS25::).

In one embodiment, the advertised addresses of network nodes 530-550 are of the format: (uSIDBlock:RoutinguSIDofNetworkNode:globalPHBuSID) or (uSIDBlock:RoutinguSIDofNetworkNode:PHBuSID), which increases the number of advertised addresses by a network node 530-550 by the number of different global or local PHB uSIDs used by that network node 530-550, and typically correspondingly increases the sizes of RIBs and FIBs on each of network nodes 530-550 to support the forwarding of packets to each of the advertised addresses.

As shown in FIG. 5D, network node 2 (520) receives and processes original IP packet 591 including apply the corresponding Segment Routing Policy (e.g., encapsulates original packet 591 in a Segment Routing packet 592 including the illustrated IPv6 Destination Address) to cause desired transmission and PHB through network 500 via network nodes 530, 540, and 550.

In one embodiment, this processing by network node 2 (520) includes generating SRv6 packet 592 with the corresponding end-to-end PHB uSID SRv6 policy (2001:db8:uS10:PHBuSID1:uS15:PHBuSID1:uS25:PHBuSID1::) in the Destination Address of SRv6 packet 592, and (low latency) correspondingly sending into network 500 SRv6 packet 592 with the IPv6 Destination Address of (2001:db8:uS10:PHBuSID1:uS15 :PHBuSID1:uS25:PHBuSID1:

SRv6 packet 592 is forwarded, based on its IPv6 Destination Address (2001:db8:uS10:PHBuSID1:uS15 :PHBuSID1:uS25 :PHBuSID1::) to network node 3 (530). Network node 530 receives SRv6 packet 592, which includes the Active uSID ordered pairing of <uS10, PHBuSID1>. Based on PHBuSID1:, network node 3 (530) identifies the PHB of low latency (SLID 1) via a lookup operation in Network Slice Mapping Table 532. This low latency processing includes generating SRv6 packet 593 by updating of the IPv6 Destination Address of received packet 592 by removing the uSIDs in the Active uSID ordered pairing and shifting the remaining uSIDs and adding two E-o-C uSIDs in the low-order bits, and (low latency) correspondingly sending into network 500 SRv6 packet 593 with the IPv6 Destination Address of (2001:db8:uS15:PHBuSID1:uS25:PHBuSID1:

SRv6 packet 593 is forwarded, based on its IPv6 Destination Address (2001:db8:uS15:PHBuSID1:uS25:PHBuSID1::) to network node 4 (540). Network node 540 receives SRv6 packet 593, which includes the Active uSID ordered pairing of <uS15, PHBuSID1>. Based on PHBuSID1:, network node 4 (540) identifies the PHB of low latency (SLID 1) via a lookup operation in Network Slice Mapping Table 542. This low latency processing includes generating SRv6 packet 594 by updating of the IPv6 Destination Address of received packet 593 by removing the uSIDs in the Active uSID ordered pairing and shifting the remaining uSIDs and adding two E-o-C uSIDs in the low-order bits, and (low latency) correspondingly sending into network 500 SRv6 packet 594 with the IPv6 Destination Address of (2001:db8:uS25:PHBuSID1::).

SRv6 packet 594 is forwarded, based on its IPv6 Destination Address (2001:db8:uS25:PHBuSID1::) to network node 5 (550). Network node 550 receives SRv6 packet 594, which includes the Active uSID ordered pairing of <uS15, PHBuSID1>. Based on PHBuSID1:, network node 5 (550) identifies the PHB of low latency (SLID 1) via a lookup operation in Network Slice Mapping Table 552. This low latency processing includes decapsulating and (low latency) correspondingly sending into network 500 original IP packet 591.

In view of the many possible embodiments to which the principles of the disclosure may be applied, it will be appreciated that the embodiments and aspects thereof described herein with respect to the drawings/figures are only illustrative and should not be taken as limiting the scope of the disclosure. For example, and as would be apparent to one skilled in the art, many of the process block operations can be re-ordered to be performed before, after, or substantially concurrent with other operations. Also, many different forms of data structures could be used in various embodiments. The disclosure as described herein contemplates all such embodiments as may come within the scope of the following claims and equivalents thereof.

What is claimed is:

1. A method, comprising:
receiving, by a particular Segment Routing node in a network, a Segment Routing version 6 (SRv6) packet including an Internet Protocol version 6 (IPv6) Destination address that is an address of the particular Segment Routing node, with the IPv6 Destination address including a plurality of micro segments (uSIDs) with a particular uSID of the plurality of uSIDs mapping to a particular Network Slice behavior of a plurality of different Network Slice behaviors performed on different packets by the particular Segment Routing node;
processing of said received SRv6 by the particular Segment Routing node including differential processing the particular SRv6 packet according to the particular Network Slice behavior, with said differential processing being different than processing according to one of the plurality of different Network Slices behaviors that is not the particular Network Slice behavior, updating of the IPv6 Destination Address comprising removing a routing uSID identifying the particular Segment Routing node and shifting into higher-order bit positions one or more uSIDs in the IPv6 Destination Address of said received SRv6 packets; and sending from the particular Segment Routing node the SRv6 packet with said updated IPv6 Destination Address.

2. The method of claim 1, comprising performing a lookup operation in a Network Slice mapping data structure resulting in identification of the particular Network Slice behavior based on the particular uSID.

3. The method of claim 2, wherein the particular uSID is a combined Per-Hop Behavior (PHB) and routing uSID indirectly identifying the particular Network Slice behavior and is part of an advertised route of the particular Segment Routing node.

4. The method of claim 2, wherein the particular uSID is a Per-Hop Behavior (PHB) uSID; wherein the particular uSID concatenated with a first routing uSID is part of an advertised route of the particular Segment Routing node; and wherein said removing the routing uSID includes removing the first routing uSID.

5. The method of claim 2, wherein the particular uSID is a Per-Hop Behavior (PHB) uSID; wherein a first routing uSID is part of an advertised route of the particular Segment Routing node; and wherein said removing the routing uSID includes removing the first routing uSID.

6. The method of claim 5, wherein the particular uSID is in lower-order bits of the IPv6 Destination address than all routing uSIDs in the IPv6 Destination Address of the received SRv6 packet.

7. The method of claim 2, wherein the IPv6 Destination Address of the received SRv6 packet includes a plurality of pairings of Per-Hop Behavior (PHB) and routing uSIDs; wherein the plurality of pairings includes a particular pairing including the particular uSID and the routing uSID; and wherein said removing the routing uSID includes removing the particular pairing.

8. The method of claim 7, wherein the particular pairing is part of an advertised route of the particular Segment Routing node.

9. The method of claim 8, wherein the particular pairing includes the particular uSID concatenated with the routing uSID.

10. The method of claim 8, wherein the particular pairing includes the routing uSID concatenated with the routing uSID.

11. The method of claim 7, wherein the routing uSID is part of an advertised route of the particular Segment Routing node.

12. The method of claim 1, wherein the particular uSID is a global Per-Hop Behavior (PHB) uSID identifying PHB to be performed one or more other Segment Routing nodes in the network.

13. The method of claim 12, wherein the particular uSID is part of an advertised route of the particular Segment Routing node.

14. The method of claim 1, wherein the IPv6 Destination Address of the received SRv6 packet includes a Flex-Algo uSID; and processing of the packet includes processing according to a Flexible Algorithm identified by the Flex-Algo uSID.

15. The method of claim 1, wherein prior to receiving the SRv6 packet, the particular Segment Routing node configures one or more hardware resources to perform differential processing for each of the plurality of different Network Slice behaviors.

16. The method of claim 15, wherein each of the plurality of Network Slice behaviors defines packet processing latency or link bandwidth capacity.

17. The method of claim 16, wherein said one or more resources includes queues, ternary content-addressable memories (TCAMs), or memory.

18. A packet switching device, comprising:
a plurality of hardware interfaces sending and receiving packets; and
one or more network processors with memory associated therewith;
wherein the packet switching device performs packet processing operations, with said packet processing operations including:
receiving via one of said hardware interfaces, a Segment Routing version 6 (SRv6) packet including an Internet Protocol version 6 (IPv6) Destination address that is an address of the packet switching device, with the IPv6 Destination address including a plurality of micro segments (uSIDs) with a particular uSID of the plurality of uSIDs mapping to a particular Network Slice behavior of a plurality of different Network Slice behaviors performed on different packets by the packet switching device;
processing of said received SRv6 by the particular packet switching device including differential processing the particular SRv6 packet according to the particular Network Slice behavior, with said differential processing being different than processing according to one of the plurality of different Network Slices behaviors that is not the particular Network Slice behavior, updating of the IPv6 Destination Address comprising removing a routing uSID identifying the packet switching device and shifting into higher-order bit positions one or more uSIDs in the IPv6 Destination Address of said received SRv6 packets; and sending from a hardware interface of the plurality of hardware interfaces the SRv6 packet with said updated IPv6 Destination Address.

19. The packet switching device of claim 18, wherein the particular uSID is a combined Per-Hop Behavior (PHB) and routing uSID indirectly identifying the particular Network Slice behavior and is part of an advertised route of the particular packet switching device.

20. The packet switching device of claim 18, wherein the particular uSID is a Per-Hop Behavior (PHB) uSID; wherein the particular uSID concatenated with a first routing uSID is part of an advertised route of the packet switching device; and wherein said removing the routing uSID includes removing the first routing uSID.

21. The packet switching device of claim 18, wherein the particular uSID is a Per-Hop Behavior (PHB) uSID; wherein a first routing uSID is part of an advertised route of the particular packet switching device; and wherein said removing the routing uSID includes removing the first routing uSID.

22. The packet switching device of claim 18, wherein the IPv6 Destination Address of the received SRv6 packet includes a plurality of pairings of Per-Hop Behavior (PHB) and routing uSIDs; wherein the plurality of pairings includes a particular pairing including the particular uSID and the routing uSID; and wherein said removing the routing uSID includes removing the particular pairing.
